(19) United States
(12) Patent Application Publication
(10) Pub. No.: US 2025/0282031 A1
(43) Pub. Date: Sep. 11, 2025

(54) TRUSS ASSEMBLY TABLE

(71) Applicant: Illinois Tool Works Inc., Glenview, IL (US)

(72) Inventors: Mathew Nickolas Milton, Carrollton, TX (US); Saed Jabari, Richardson, TX (US)

(21) Appl. No.: 19/065,587

(22) Filed: Feb. 27, 2025

Related U.S. Application Data
(60) Provisional application No. 63/562,419, filed on Mar. 7, 2024.

(51) Int. Cl. B25B 11/02; B23Q 15/22

(52) U.S. Cl. CPC B25B 11/02; B23Q 15/22

(57) ABSTRACT

A truss assembly table and methods of operating a truss assembly table, wherein the truss assembly table includes one or more of truss ejection assemblies, truss end stop assemblies, and a control system and gantry with a sensor assembly.

### PRIORITY CLAIM

This application claims priority to and the benefit of U.S. Provisional Patent Application No. 63/562,419, filed Mar. 7, 2024, the entire contents of which are incorporated herein by reference.

### BACKGROUND

Wooden trusses are widely used throughout the construction industry. Wooden trusses are often built from conventional dimensional lumber members (such as what is commonly known as: a 2 by 4; a 2 by 6; a 2 by 8; etc.). The wooden members that are used to build a wooden truss are sometimes called truss members in general with the most common truss member types sometimes called chord members and web members. Such chord members extend longitudinally along the length of the truss and such web members extend transversely to the length of the truss such as along the width of the truss. A wooden truss is often built from numerous wooden truss members and metal connectors. The metal connectors are used to attach the truss members to build the wooden truss. Wooden trusses are often prefabricated in a factory and then shipped to a construction site where the wooden trusses are used to construct part of the structure of a building (such as a house or commercial facility). Buildings constructed with such prefabricated wooden roof trusses are often more economical and faster to construct than buildings constructed with conventional stick framed structures.

Various truss assembly tables have been developed and commercialized.

One issue with various known truss assembly tables is that they are only configured to eject the built trusses from the side of the truss assembly tables. In other words, such various known truss assembly tables are not configured to eject the built trusses from either or both of the ends of the truss assembly tables.

Another issue with various known truss assembly tables is that they are not configured to automatically control the movement of the gantry of the truss assembly table that fully secures the connector plates to the truss members such as the chord members and web members.

### SUMMARY

The present disclosure provides truss assembly tables, methods of operation thereof, and various components and combinations of components thereof.

In various embodiments, the present disclosure relates to a truss assembly table including a plurality of truss ejection assemblies configured to simultaneously be in: (1) retracted positions where the truss ejection assemblies are at or below the top surface of the table top of the truss assembly table; and (2) extended positions wherein rollers of the truss ejections assemblies raise above the top surface of the table top of the truss assembly table and engage, raise, and eject a truss built on the truss assembly table from an end of the truss assembly table. In various embodiments, the present disclosure also relates to each such truss ejection assembly configured to installed as part of a truss assembly table. In various embodiments, the present disclosure also relates to methods of operating such truss ejection assemblies.

In various embodiments, the present disclosure relates to a truss assembly table including a truss end stop assembly configured to be in: (1) an engagement position where the truss end stop assembly is configured to engage one or more end truss members of the truss during building of the truss on the truss assembly table; and (2) a non-engagement position where the truss end stop assembly is dis-engaged from the end truss member(s) of the built truss and enables the built truss to move above the truss end stop assembly as the built truss is ejected from an end of the truss assembly table. In various embodiments, the present disclosure also relates to such a truss end stop assembly configured to installed as part of a truss assembly table. In various embodiments, the present disclosure also relates to methods of operating such truss end stop assembly or assemblies.

In various embodiments, the present disclosure relates to a truss assembly table including a control system and a gantry including a sensor assembly configured to co-act to sense movement of a gear component of the gantry drive assembly and to determine distances of movement of the gantry and/or to control the distances of movement of the gantry in along the table top (such as in forward and backward directions). In various embodiments, present disclosure also relates to such a control system and sensor assembly configured to installed as part of a truss assembly table. In various embodiments, the present disclosure also relates to methods of operating such a control system and gantry including a sensor assembly.

In various embodiments, the present disclosure relates to a truss assembly table including: (1) such truss ejection assemblies; and (2) such truss end stop assembly. In various embodiments, the present disclosure also relates to methods of operating such components.

In various embodiments, the present disclosure relates to a truss assembly table including: (1) such truss ejection assemblies; (2) such truss end stop assembly; and (3) such control system and gantry with a sensor assembly. In various embodiments, the present disclosure also relates to methods of operating such components.

In various embodiments, the present disclosure relates to a truss assembly table including: (1) such truss ejection assemblies; and (2) such control system and gantry with a sensor assembly. In various embodiments, the present disclosure also relates to methods of operating such components.

In various embodiments, present disclosure relates to a truss assembly table including: (1) such truss end stop assembly; and (2) such control system and gantry including a sensor assembly. In various embodiments, the present disclosure also relates to methods of operating such components.

In various embodiments, present disclosure also relates to a truss assembly table including a table frame and/or table top that includes an upwardly extending set of spaced apart ramps at each end thereof. The gantry is configured to travel upwardly on each set of ramps and thus be spaced a further distance from the top of the table top. This better enables a built truss to move under the gantry as the built truss is ejected from an end of the truss assembly table.

Additional features and advantages of the present disclosure are described in, and will be apparent from, the following Detailed Description and the Figures.

### BRIEF DESCRIPTION OF THE FIGURES

FIG. 1 is a top perspective view of a truss assembly table in accordance with one example embodiment of the present disclosure.

FIG. 2 is a top view of the truss assembly table of FIG. 1.

FIG. 3 is an enlarged fragmentary partial cross-sectional and partial perspective view of part of the truss assembly table of FIG. 1, showing one of the truss ejection assemblies thereof in a retracted position.

FIG. 4 is an enlarged perspective view of the truss ejection assembly of FIG. 3 shown removed from the truss assembly table, and wherein the truss ejection assembly is in the retracted position.

FIG. 5 is an enlarged fragmentary partial cross-sectional and partial perspective view of part of the truss ejection assembly of FIG. 1, and wherein the truss ejection assembly is in an extended position.

FIG. 6 is an enlarged perspective view of the truss ejection assembly of FIG. 3 shown removed from the truss assembly table, and wherein the truss ejection assembly is in the extended position.

FIG. 7 is an enlarged fragmentary perspective view of part of the truss assembly table of FIG. 1, showing the truss end stop assembly at one end to the truss assembly table, and wherein the truss end stop assembly is in a lower non-engagement position.

FIG. 8 is a further enlarged fragmentary partial cross-sectional and partial perspective view of part of the truss assembly table of FIG. 1, showing the truss end stop assembly at one end to the truss assembly table, and wherein the truss end stop assembly is in a lower non-engagement position.

FIG. 9 is a further enlarged fragmentary partial cross-sectional and partial perspective view of part of the truss assembly table of FIG. 1, showing the truss end stop assembly at one end to the truss assembly table, and wherein the truss end stop assembly is in an upper engagement position.

FIG. 10 is a further enlarged perspective view of the truss end stop assembly of FIG. 7 shown removed from the truss assembly table, and wherein the truss end stop assembly is in the upper engagement position.

FIG. 11 is a further enlarged fragmentary partial cross-sectional and partial perspective view of part of the truss assembly table of FIG. 1, showing the truss end stop assembly at one end to the truss assembly table, and wherein the truss end stop assembly is in a lower non-engagement position.

FIG. 12 is a further enlarged perspective view of the truss end stop assembly of FIG. 7 shown removed from the truss assembly table, and wherein the truss end stop assembly is in the lower non-engagement position.

FIG. 13 is an enlarged fragmentary perspective view of part of the truss assembly table of FIG. 1 showing part of the gantry thereof with a side cover of the gantry removed.

FIG. 14 is an enlarged fragmentary side view of part of the gantry of the truss assembly table of FIG. 1 with the side cover of the gantry removed.

FIG. 15 is an enlarged fragmentary partial cross-sectional front end view of part of the gantry of the truss assembly table of FIG. 1 with the side cover of the gantry removed.

FIG. 16 is a further enlarged fragmentary side view of part of the gantry of the truss assembly table of FIG. 1 with the side cover of the gantry removed.

FIG. 17 is a still further enlarged fragmentary side view of part of the gantry of the truss assembly table of FIG. 1 with the side cover of the gantry removed.

### DETAILED DESCRIPTION OF EXAMPLE EMBODIMENTS

While the systems, devices, and methods described herein may be embodied in various forms, the drawings show, and the specification describes certain exemplary and non-limiting embodiments. Not all components shown in the drawings and described in the specification may be required, and certain implementations may include additional, different, or fewer components. Variations in the arrangement and type of the components; the shapes, sizes, and materials of the components; and the manners of connections of the components may be made without departing from the spirit or scope of the claims. Unless otherwise indicated, any directions referred to in the specification reflect the orientations of the components shown in the corresponding drawings and do not limit the scope of the present disclosure. Further, terms that refer to mounting methods, such as mounted, connected, etc., are not intended to be limited to direct mounting methods but should be interpreted broadly to include indirect and operably mounted, connected, and like mounting methods. This specification is intended to be taken as a whole and interpreted in accordance with the principles of the present disclosure and as understood by one of ordinary skill in the art.

Various embodiments of the present disclosure relate to truss assembly tables and particularly provide a truss assembly table with: (1) multiple truss ejection assemblies configured to eject built trusses from an end of the truss assembly table; (2) one or more truss end stop assemblies configured to secure one or more truss member(s) of the truss while the truss is being built on the truss assembly table and to move downwardly to enable the built truss to move over the truss end stop assembly and to be ejected from an end of the truss assembly table; and (3) a control system and gantry including a sensor assembly. Thus, in various embodiments, the present disclosure relates to truss assembly tables with all three of: (1) the truss ejection assemblies; (2) the truss end stop assembly; and (3) the control system and gantry with the sensor assembly. Various embodiments of the present disclosure also relate to methods of operating a truss assembly table with such components.

In various embodiments, the present disclosure relates to truss assembly tables with two of but not all of: (1) the truss ejection assemblies; (2) the truss end stop assembly; and (3) the control system and gantry with the sensor assembly. Various embodiments of the present disclosure also relate to methods of operating a truss assembly table with such components.

In various embodiments, the present disclosure relates to truss assembly tables with only one of: (1) the truss ejection assemblies; (2) the truss end stop assembly; and (3) the control system and gantry with the sensor assembly. Various embodiments of the present disclosure also relate to methods of operating a truss assembly table with such components.

In various embodiments, the present disclosure relates individually to each of: (1) the truss ejection assemblies; (2) the truss end stop assembly; and (3) the control system and gantry with the sensor assembly.

In various embodiments, the present disclosure also relates to methods of operation (jointly or separately) of each of: (1) the truss ejection assemblies; (2) the truss end stop assembly; and (3) the control system and gantry with sensor assembly, on a truss assembly table, and/or the operation of the truss assembly table with one or more or all of these components.

In various embodiments, present disclosure also relates to a truss assembly table including a table frame and/or table top that includes an upwardly extending set of spaced apart ramps at one or both ends of the table frame and/or table top. In such embodiments, the gantry is configured to travel upwardly on each set of ramps and thus be spaced a further distance from the top surface of the table top. This better enables a built truss to move under the gantry as the built truss is ejected from an end of the table.

Example embodiments of the truss assembly table including these components of the present disclosure are discussed below; however, it should be appreciated that the present disclosure is not limited to the illustrated example truss assembly tables or the example components.

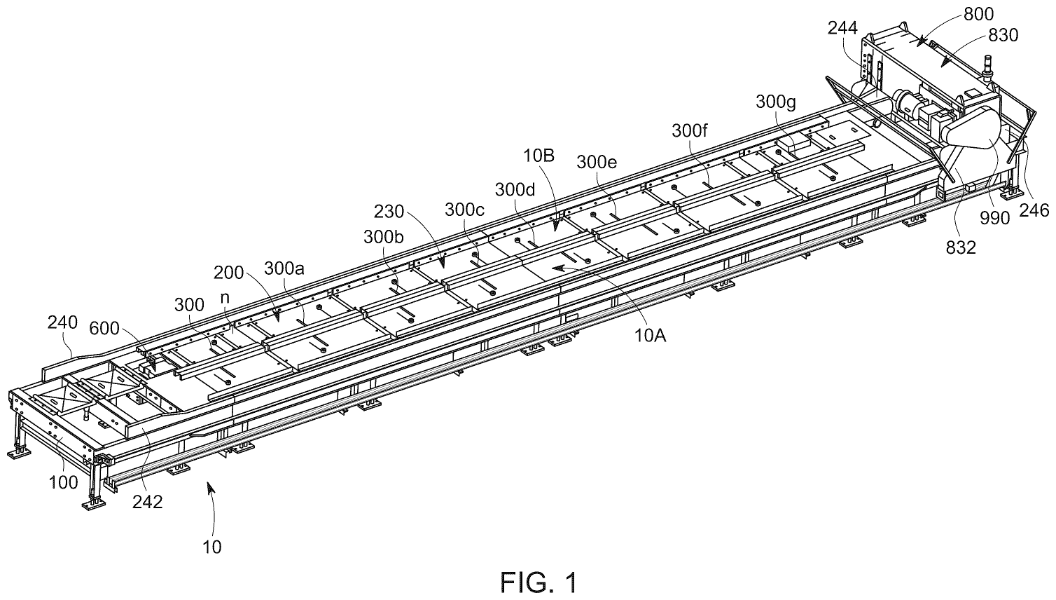

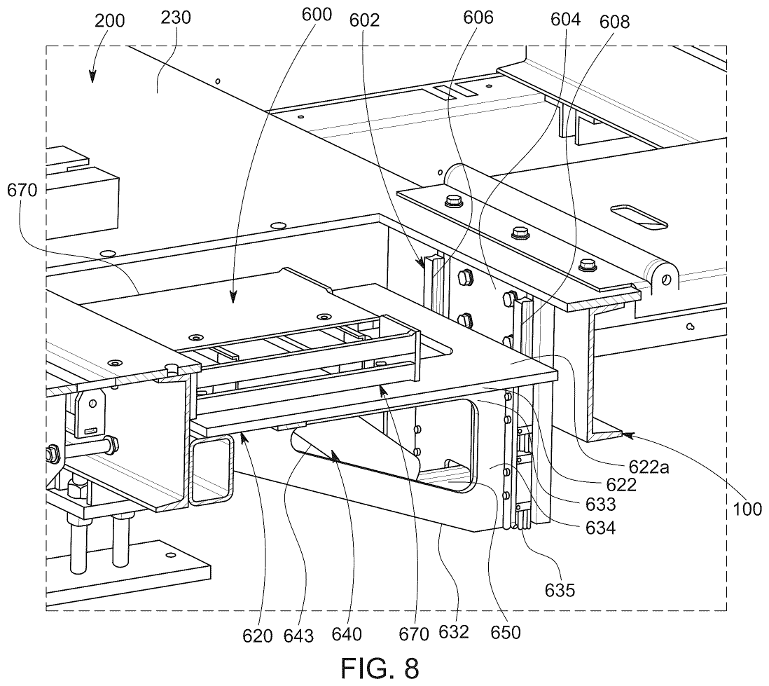

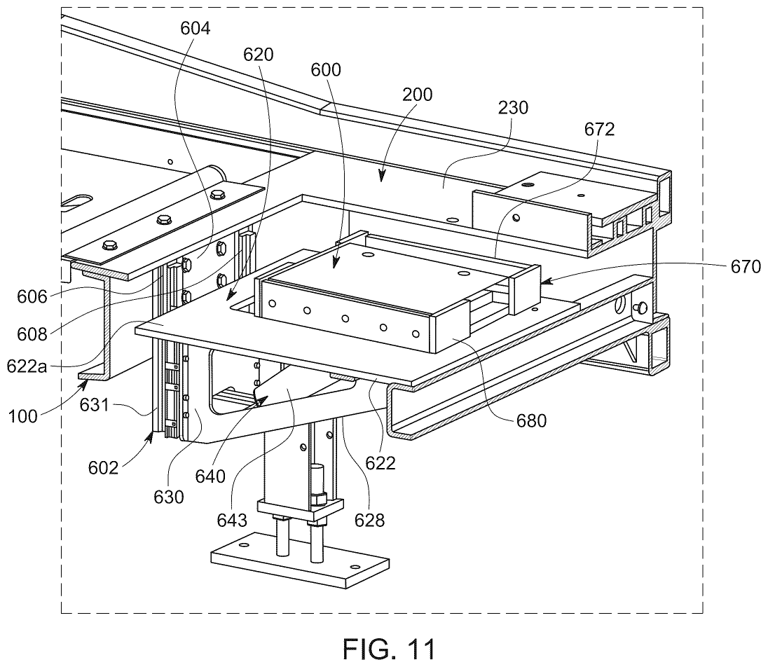

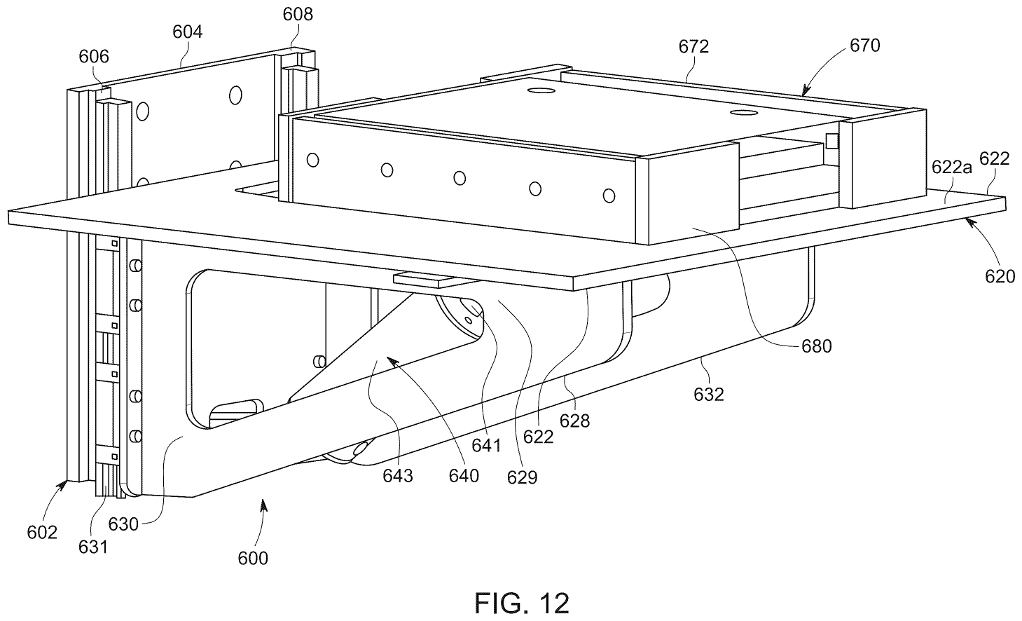

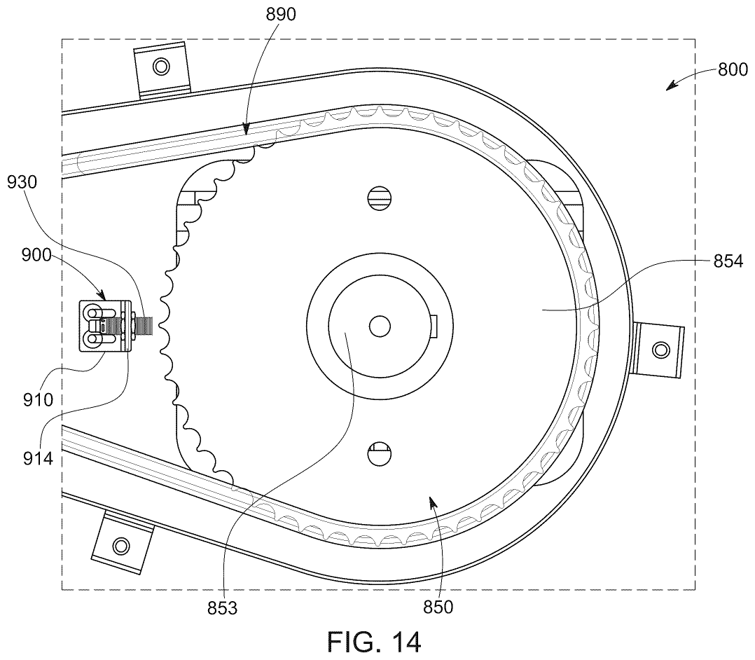

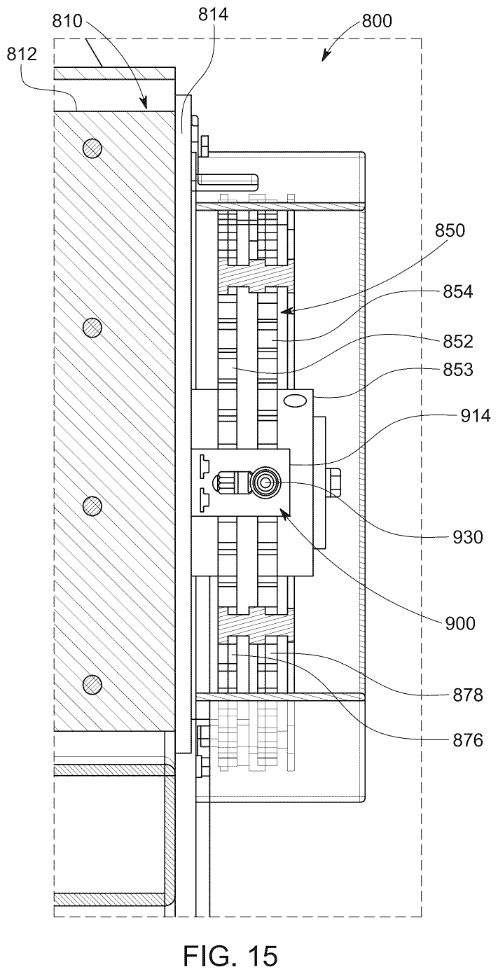

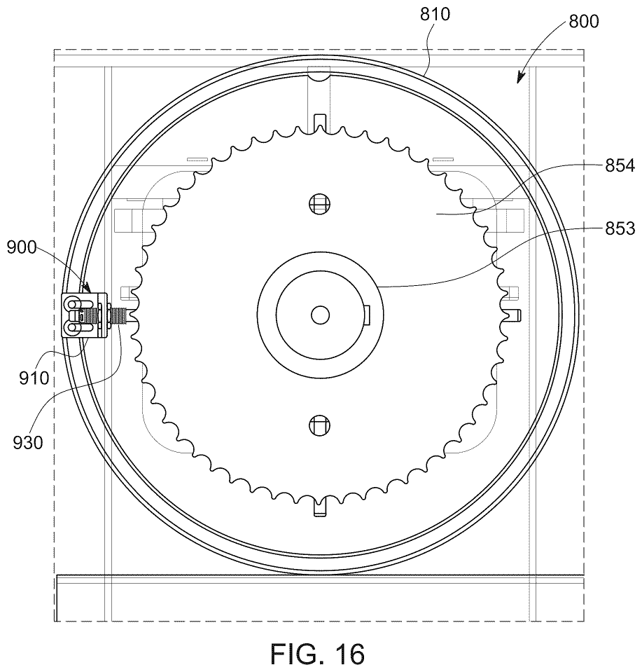

FIGS. 1 to 17 show a truss assembly table 10 (and various components thereof) of one example embodiment of the present disclosure. This example truss assembly table 10 generally includes: (a) a table frame 100; (2) a table top 200; (3) a plurality of spaced-apart ejection assemblies 300, 300a, 300b, 300c, 300d, 300e, and 300f; (4) a truss end stop assembly 600; (5) a movable gantry 800; (6) a control system (not shown); (7) an operator interface (not shown); and (8) a power supply (not shown).

For brevity, various components of this example truss assembly table 10 of the present disclosure are not described herein because such components are well known in the truss assembly table industry.

This example truss assembly table 10 is configured for simultaneously building two trusses (such as two floor trusses) on the table top 200 of the truss assembly table 10 (i.e., one on each side in and end-to-end manner on the table top 200). Generally, to build a truss on the table top 200 of the truss assembly table 10: (1) the truss members (not shown) and first side connectors (not shown) for a truss are first positioned on the first side 10A of the truss assembly table 10 and the truss members are held in place by puck assemblies (not shown in detail or labeled); (2) the gantry 800 moves from a first end of to a second end of the table top 200 over the truss members and first side connectors to fully secure those first side connectors to the truss members; (3) the partially build truss is then flipped over from the first side 10A to the second side 10B of the truss assembly table 10; and (4) the gantry 800 then moves from the second end back to the first end of the table top 200 over the truss member and second side connectors to fully secure second side connectors to the truss members and thus to complete the building of the truss. The built truss is then removed from an end of the second side 10B of the truss assembly table 10. The process of removing the truss includes lowering the end stop assembly (described below) and raising the truss ejection assemblies (described below) to lift the built truss on the second side 10B of the truss assembly table 10, and then causing the truss ejections assemblies to move the built truss longitudinally over the lowered end stop assembly and off of an end of the truss assembly table 10. Thus, a first truss can be built on the first side 10A while a second truss is built on the second side 10B at the same time (although the stages of the building process for the first and second trusses will be different).

More specifically, the table frame 100 includes a plurality of frame components (not individually labeled) that are configured and attached in a suitable manner to support the other components of the truss assembly table 10. These frame components can take any suitable shape, can be formed is any suitable manner, and can be formed from any suitable materials. The table frame 100 has a longitudinal length that is longer than any truss that will be built on the truss assembly table 10. The table frame 100 also has a transverse width that is more than twice the width of any truss that will be built on the truss assembly table 10, so as to enable two trusses (such as but not limited to floor trusses) to be simultaneously built on the truss assembly table 10.

The table top 200 is supported by the table frame 100, has a longitudinal length that is longer than any truss that will be built on the truss assembly table 10, and has a transverse width that is more than twice the width of any truss that will be built on the truss assembly table 10, so as to enable two trusses (such as but not limited to floor trusses) to be simultaneously built on the truss assembly table 10 as explained above. The table top 200 includes one or more horizontally extending members (not labeled), wherein the upper most member(s) form an upper build surface 230 on which trusses being built on the truss assembly table 10 can rest. The table top 200 can be formed is any suitable manner and can be formed from any suitable materials.

The table frame 100 and the table top 200 can be formed as a single table or from multiple joined tables.

The table top 200 includes: (1) a first set of upwardly extending spaced apart ramps 240 and 242; (2) a second set of upwardly extending spaced apart ramps 244 and 246, at the respective ends of the truss assembly table 10. The gantry 800 is configured to travel upwardly on each set of ramps and thus be spaced further from the top surface 230 of the table top 200. This better enables a built truss to move under the gantry 800 as the built truss is ejected from and end of the truss assembly table 10. The ramps can be only at one end of the truss assembly table and can be otherwise configured. In various embodiments, the truss assembly table includes only one set of ramps that enable the gantry to be moved upwardly. In various other embodiments, present disclosure contemplates that other mechanisms can be employed to raise the gantry if needed.

In various other embodiments, the table top 200 includes one but not both sets of the upwardly extending spaced apart ramps, at one of the ends of the truss assembly table 10.

The multiple evenly spaced-apart truss ejection assemblies 300, 300a, 300b, 300c, 300d, 300e, and 300f are all identical in this example embodiment, and thus for brevity, only the truss ejection assembly 300 is described herein in detail. The truss ejection assemblies 300, 300a, 300b, 300c, 300d, 300e, and 300f are configured to simultaneously be in: (1) retracted positions where the truss ejection assemblies are at or below the top surface 230 of the table top 200 of the truss assembly table 10; and (2) extended positions where the rollers (not all labeled) of the truss ejections assemblies 300, 300a, 300b, 300c, 300d, 300e, and 300f engage, raise, and eject a truss built on the truss assembly table 10 from an end of the truss assembly table 10. The quantity and positions of the truss ejections assemblies can vary in accordance with the present disclosure. The truss ejections assemblies are configured to support the entire weight of the built truss in accordance with the present disclosure.

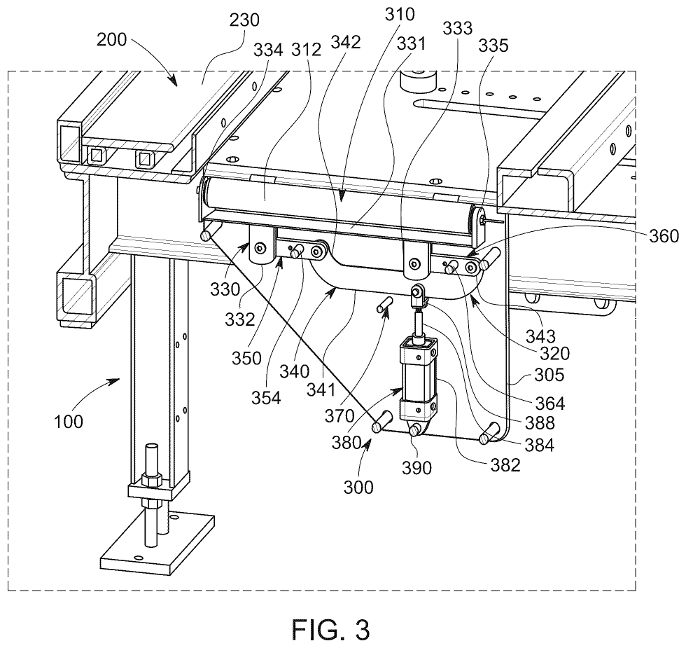

As best shown in FIGS. 3, 4, 5, and 6, the example truss ejection assembly 300 generally includes: (1) a support assembly 304; (2) a truss mover 310; (3) an actuation assembly 320; and (4) an actuator 380.

The support assembly 304 include supports 305 and 306 and fasteners (not labeled). The support assembly 304 is configured to be fixedly connected to and supported by the table frame 100. The support assembly 304 is configured to support the truss mover 310, the actuation assembly 320, and the actuator 380 such as shown in FIGS. 3, 4, 5, and 6. The support assembly 304 is made from suitable metal components, but can be made from other suitable materials and formed in other suitable configurations.

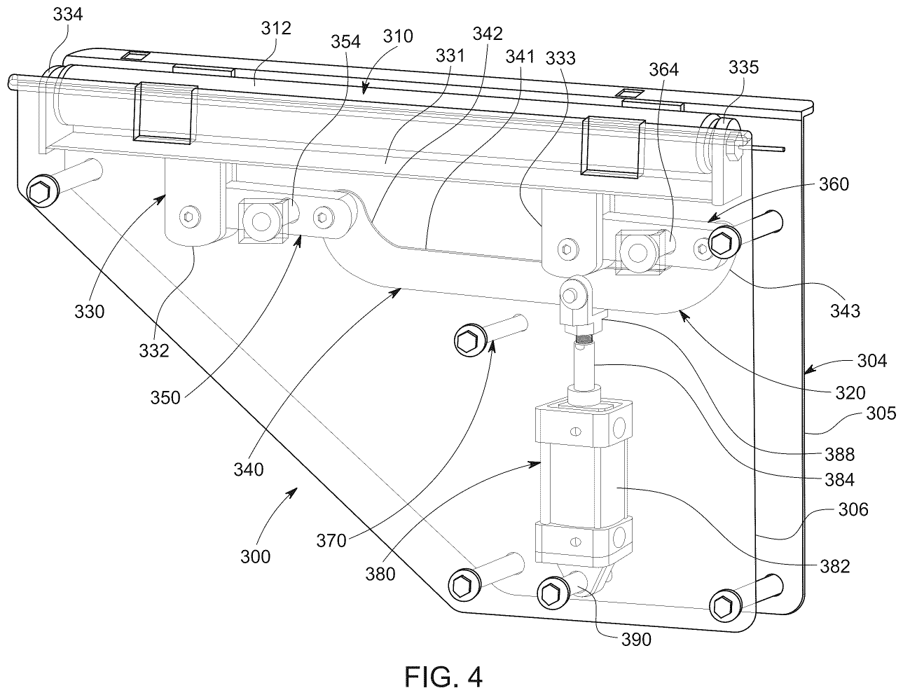

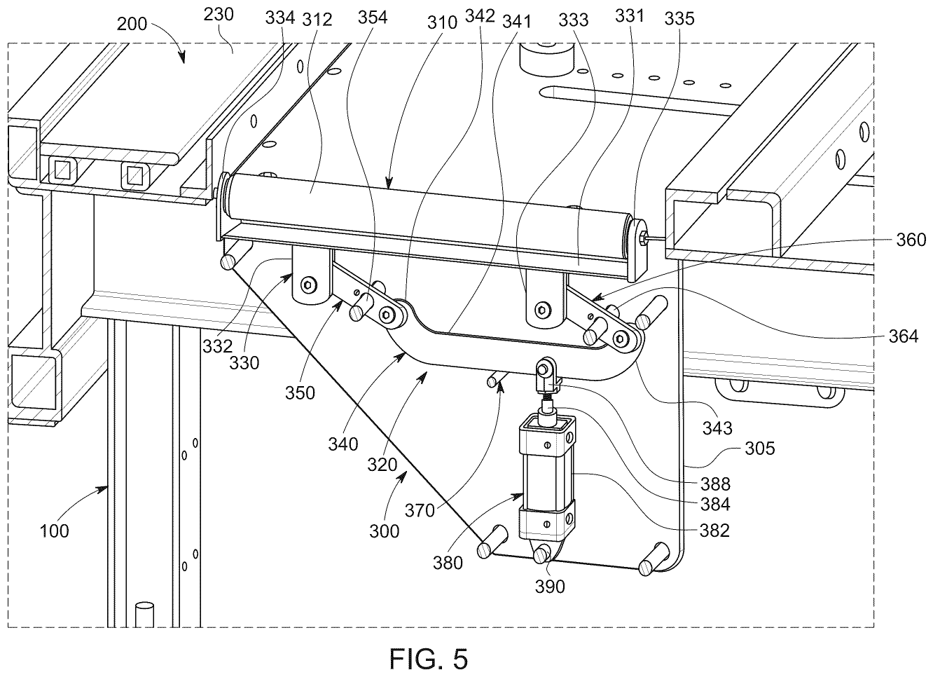

The truss mover 310 includes a powered roller such as a cylindrical driven rotatable roller 312 rotatably supported at opposite ends (not labeled) by upwardly extending roller supports 334 and 335 that are part of the actuation assembly 330 (as described below). The truss mover 310 includes a suitable roller actuator (not shown) such as a motor (not shown) controlled by the control system and configured to rotate the roller 312 in either direction. The roller 312 extends transversely to the table top 130. The truss mover 310 is configured to be moved upwardly through a transversely extending opening (not labeled) in the table top 230 from a retracted position below the table top 230 (such as shown in FIG. 3) to an extended position at least partially above the table top 230 (such as shown in FIGS. 4 and 5). In the retracted position, the top of the roller 312 of the truss mover 310 is below or even with the top surface 230 of the table top 200 so as not to interfere with the building of the truss on the second side 10B of the truss assembly table 10. In the extended position, the roller 312 of the truss mover 310 (in conjunction with the rollers of the other truss ejection assemblies 300a, 300b, 300c, 300d, 300e, and 300f) is configured to vertically lift and longitudinally move a built truss positioned on the second side 10B of the truss assembly table 10 as described herein. It should be appreciated that in other embodiments, the truss assembly table include only the features of side 10B of this example embodiment. In certain such embodiments, the gantry can be narrower.

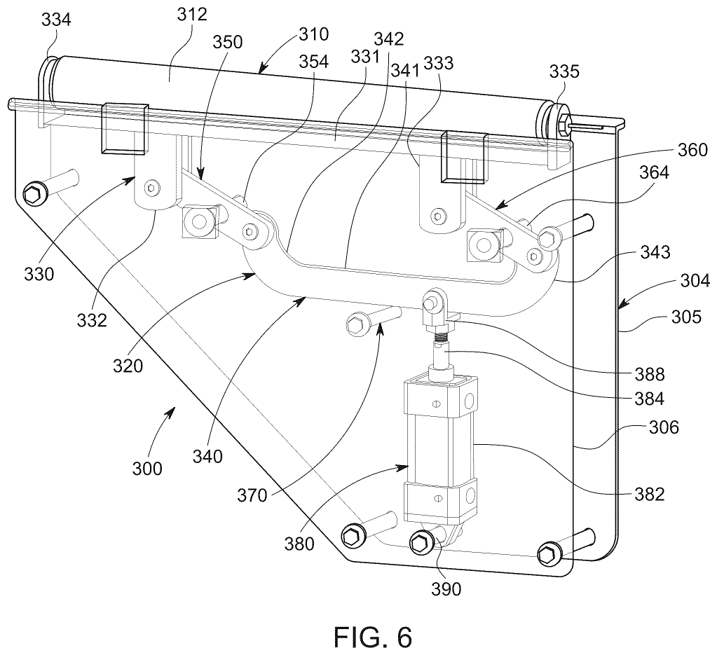

The actuation assembly 320 includes: (1) an upper section 330; (2) a lower section 340; (3) a first hinge 350 connected to the upper section 330 and to the lower section 340; (4) a second hinge 360 connected to the upper section 330 and to the lower section 340; and (5) a first stop 370. The first hinge 350 connects the upper section 330 to the lower section 340. The second hinge 360 also connects the upper section 330 to the lower section 340. The actuation assembly 320 is configured to be moved and particularly pivot upwardly via such hinges 350 and 360 to move the roller 312 from the lower position (such as shown in FIGS. 3 and 4) to the upper position (such as shown in FIGS. 5 and 6).

More specifically, the upper section 330 includes: (1) a roller support 331; (2) a first pair of legs 332 fixedly connected to and extending downwardly from the roller support 331; (3) a second pair of legs fixedly 333 connected to and extending downwardly from the roller support 331; (4) a first roller end support 334 fixedly connected to and extending upwardly from the roller support 331; and (5) a second roller end support 335 fixedly connected to and extending upwardly from the roller support 331.

Each of the first pair of legs 332 is pivotally connected to the first hinge 350 and each of the second pair of legs 333 is pivotally connected to the second hinge 360 such that the pivoting of the hinges 350 and 360 cause these pairs of legs 332 and 333, the roller support 331, and the roller 312 to move upwardly or downwardly.

The roller support 331 extends under the roller 312 and supports the roller 312. The first roller end support 334 supports a first end of the roller 312 such that the roller 312 can rotate relative to the first roller end support 334. The second roller end support 335 supports an opposite second end of the roller 312 such that the roller 312 can rotate relative to the second roller end support 335.

The lower section 340 includes: (1) an actuation arm 341; (2) a first actuation hand 342 fixedly connected to and extending upwardly from a first end (not labeled) of the actuation arm 341; and (3) a second actuation hand 343 fixedly connected to and extending upwardly from an opposite second end (not labeled) of the actuation arm 341.

The first actuation hand 342 is pivotally connected to the first hinge 350 and the second actuation hand 343 is pivotally connected to the second hinge 360 such that movement of the actuation arm 342 upwardly or downwardly causes the pivoting of the hinges 350 and 360 upwardly or downwardly.

The first hinge 350 includes: (1) a first end (not labeled) pivotally connected to the first pair of legs 332 by a first pivot pin (not labeled); (2) a second end (not labeled) pivotally connected to the first actuation hand 342 by a second pivot pin (not labeled); and (3) an intermediate section (not labeled) pivotally mounted on a pivot pin 354 that is fixedly connected to the support assembly 304. The pivot pin 354 is connected to and supported by supports 305 and 306.

The second hinge 360 includes: (1) a first end (not labeled) pivotally connected to the second pair of legs 333 by a third pivot pin (not labeled); (2) a second end (not labeled) pivotally connected to the second actuation hand 343 by a fourth pivot pin (not labeled); and (3) an intermediate section (not labeled) pivotally mounted on a pivot pin 364 that is fixedly connected to the support assembly 304. The pivot pin 364 is connected to and supported by supports 305 and 306.

The first stop 370 is configured to limit the downward movement of the lower section 340, and thus limit the upward movement of the upper section 330 and the roller 312, as best shown in FIGS. 5 and 6.

The actuator 380 includes an upper end (not labeled) and an opposite lower end (not labeled). The lower end of the actuator 380 is pivotally connected to a mount 390 that is fixedly connected to the support assembly 304. The actuator 380 extends between the lower section 340 of the actuation assembly 320 and the mount 390. In the example embodiment, the actuator 380 includes a pneumatically powered cylinder (not labeled) controlled by the control system (such as via an air compressor (not shown) controlled by the control system. More specifically, the actuator 380 includes a housing 382 and a piston rod 384 moveable with respect to the housing 382. The piston rod 384 has a first end (not shown) positioned in the housing 382 and a second end (not labeled) exterior to the housing 382 and pivotally attached by a coupler 388 to the lower section 340 of the actuation assembly 320. The actuator 380 is pneumatically powered in this example embodiment and thus includes one or more air inlet/outlet ports (not shown). However, it should be appreciated that the actuator 380 can be powered in other suitable manners in accordance with the present disclosure. For example, the actuator can include a suitably electrically powered solenoid.

The actuator 380 is configured to move the actuation assembly 320. More specifically, the actuator 380 has a non-actuated configuration shown in FIGS. 3 and 4 and an actuated configuration shown in FIGS. 5 and 6. In the non-actuated configuration, the actuator 380 causes the actuation assembly 320 to be in its lower position as shown in FIGS. 3 and 4. In the actuated configuration, the actuator 380 causes the actuation assembly 320 to be in its upper position as shown in FIGS. 5 and 6. More specifically, when the actuator 380 retracts the piston rod 384: (1) the piston rod 384 via the coupler 388 pulls the lower section 340 of the actuation assembly 320 downwardly, (2) which causes the hinges 350 and 360 to pivot from their horizontally extending positions shown in FIGS. 3 and 4 to upwardly angled positions shown in FIGS. 5 and 6, (3) which causes the upper section 310 to move upwardly, and (4) which causes the roller 312 to move upwardly. As the roller 312 moves upwardly, it moves above the top surface 230 of the table top 200 and engages the built truss (not shown) on the table top 200. This causes the upward movement of the built truss. The roller 312 can then rotate to move the built truss from an end of the truss assembly table 10.

Thus, in this example embodiment, the single actuator 380 is configured to move the roller 312 from its retracted position to its extended position to engage and eject a built truss on the second side 10B of the truss assembly table 10. The roller 312 co-acts with all of the other rollers of the other truss ejection assemblies 300a, 300b, 300c, 300d, 300e, and 300f to lift and eject the built truss.

The truss assembly table 10 can have one or two truss end stop assemblies, wherein each truss end stop assembly is positioned toward a respective end of table top 200. The truss end stop assemblies can be identical so only truss end stop assembly 600 is described herein for brevity.

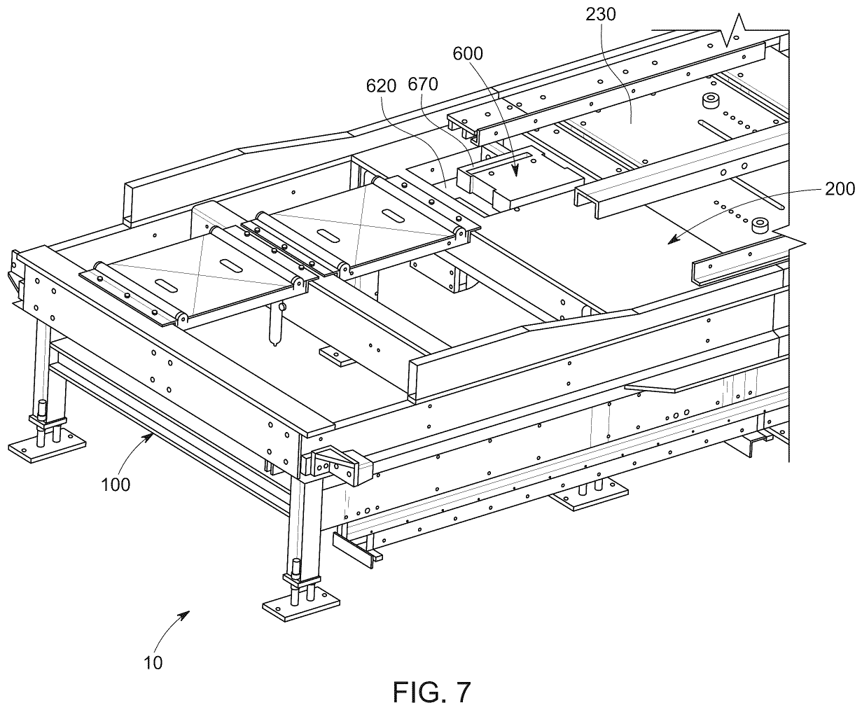

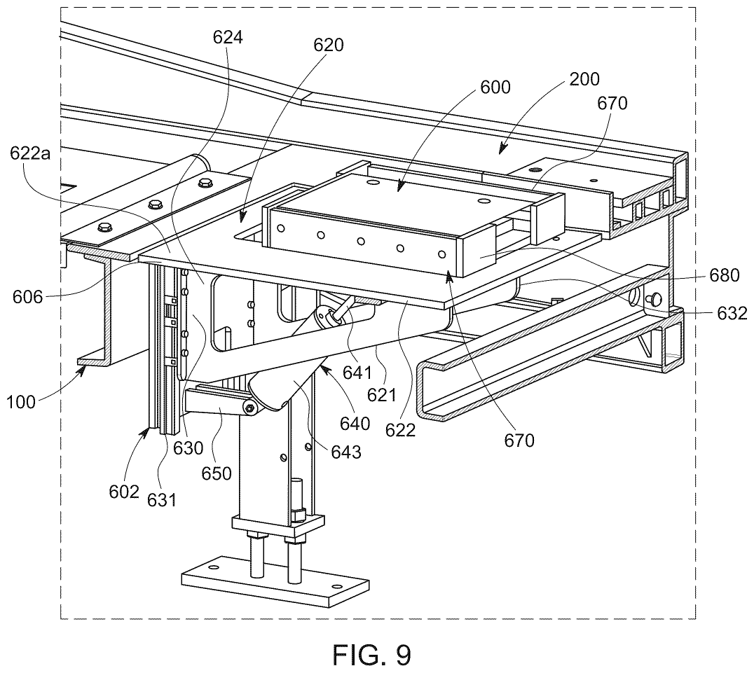

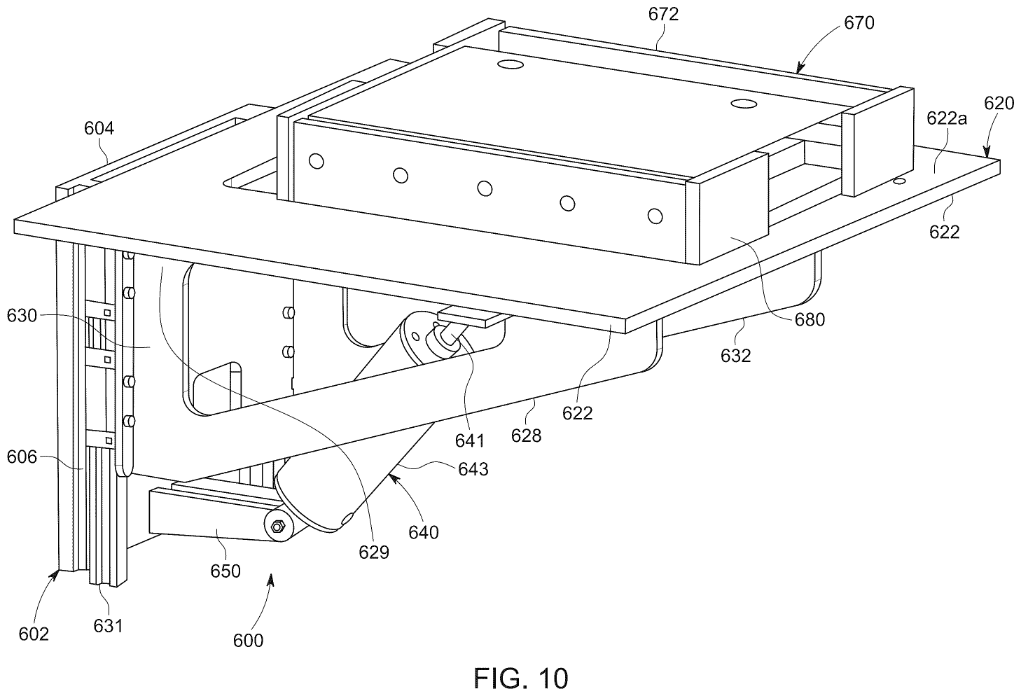

The example truss end stop assembly 600 generally includes: (1) a mounting support 602 fixedly connected to and supported by the table frame 100; (2) a platform 620 vertically movably connected to the mounting support 602; (3) a platform actuation assembly 640 connected to the mounting support 602 and the platform 620; and (4) an end stop 670 positioned on, connected to, and supported by the platform 620. The platform 620 and the end stop 670 are thus supported by the mounting support 602 and movable by the platform actuation assembly 640: (1) to an engagement position (shown in FIGS. 9 and 10) where the end stop 670 is configured to engage one or more end truss member(s) of the truss during building of the truss on the second side 10B of the truss assembly table 10; and (2) to a non-engagement position (shown in FIGS. 7, 8, 11, and 12) where the truss end stop assembly 600 is configured to be dis-engaged from the end truss member(s) of the built truss on the second side 10B of the truss assembly table 10 and enable the built truss to move above the truss end stop assembly 600 as the built truss is ejected from an end of the truss assembly table 10.

More specifically, the mounting support 602 includes: (1) a mounting plate 604; (2) a first guide rail 606 fixedly connected to and supported by the mounting plate 604; and (3) a second guide rail 608 fixedly connected to and supported by the mounting plate 604. The mounting support 602 is made from suitable metal components but can be made from other suitable materials and in other suitable configurations.

The mounting plate 604 is fixedly connected to and supported by the table frame 100. The mounting plate 604 is configured to support the platform 620, the platform actuation assembly 640, and the end stop 670, such as shown in FIGS. 7, 8, 9, and 11.

The first guide rail 606 is fixedly connected to and supported by the mounting plate 604, extends vertically along the mounting plate 604, and extends transversely from the mounting plate 604. The first guide rail 606 is configured to be coupled to the first support bracket 628 of the platform 628 such as described below.

The second guide rail 608 is fixedly connected to and supported by the mounting plate 604, extends vertically along the mounting plate 604, and extends transversely from the mounting plate 604. The second guide rail 608 is spaced-apart from the first guide rail 606. The second guide rail 608 is configured to be coupled to the second support bracket 632 of the platform 628 such as described below.

The platform 620 includes: (1) an upper base 622; (2) a first support bracket 628; and (3) a second support bracket 632. The platform 620 is made from suitable metal components but can be made from other suitable materials and in other suitable configurations.

The upper base 622 is configured to support the end stop 670. The upper base 622 includes a top surface 622a that is configured to be flush with the top surface 230 of the table top 200 when the end stop assembly 600 (including the platform 620 and the end stop 670) are in the engagement position (shown in FIGS. 9 and 10). In such position, the end stop 670 is configured to engage one or more end truss members of the truss during building of the truss on the second side 10B of the truss assembly table 10. In such position, parts of the truss members including one or more end members that form the truss can rest on part of the top surface 622a of the upper base 622 of the platform 620.

The first support bracket 628 includes: (1) an upper portion 629 that is fixedly connected to the bottom of the base 622; and (2) a side portion 630 connected to a first guide 631 that is coupled to and slidable relative to the first guide rail 606 such that the first bracket 628 is slidable relative to the first guide rail 606 and the mounting plate 604.

The second support bracket 632 includes: (1) an upper portion 633 that is fixedly connected to the bottom of the base 622; and (2) a side portion 634 connected to a second guide 635 that is coupled to and slidable relative to the second guide rail 608 such that the second bracket 632 is slidable relative to the second guide rail 608 and the mounting plate 604.

The platform actuation assembly 640 includes: (1) an actuator 643; (2) a first mount 650; and (3) a second mount (not shown). The platform actuation assembly 640 is mainly made from suitable metal components but can be made from other suitable materials and in other suitable configurations.

The actuator 643 includes an upper end (not labeled) and an opposite lower end (not labeled). The lower end (not labeled) of the actuator 643 is pivotally connected to the first mount 650 that is fixedly connected to the mounting plate 604 of the mounting support 602. The upper end (not labeled) of the actuator 643 is pivotally connected to the second mount that is fixedly connected to the bottom of the base 622 of the platform 620.

In the example embodiment, the actuator 643 includes a pneumatically powered cylinder (not shown or labeled) controlled by the control system (such as via an air compressor (not shown) controlled by the control system). The actuator 643 includes a housing (not labeled) and a piston rod 641 moveable with respect to the housing. The piston rod 641 has a first end (not shown) positioned in the housing and a second end (not labeled) exterior to the housing and pivotally attached to the second mount. The actuator 643 is pneumatically powered in this example embodiment and thus includes one or more air inlet/outlet ports (not shown). However, it should be appreciated that the actuator 643 can be powered in other suitable manners in accordance with the present disclosure. For example, the actuator can include a suitably electrically powered solenoid.

The actuator 643 is configured to move the platform 620 (and thus the end stop 670 on the platform 620). The actuator 380 has a non-actuated configuration and an actuated configuration. In the non-actuated configuration, the actuator 643 causes the platform 620 to be in its lower position as shown in FIGS. 7, 8, 11, and 12. In the actuated configuration, the actuator 643 causes the platform 620 to be in its upper position as shown in FIGS. 9 and 10. Thus, in this example embodiment, the actuator 643 is configured to move the platform 620 (and thus the end stop 670 on the platform 620) from the upper engagement position to the lower non-engagement position such that a built truss can be moved over the end stop 670 and the platform 620 to be removed from and end of the truss assembly table 10.

The end stop 670 includes: (1) an end stop housing 672; and (2) an extendable stopping member 680 supported by the end stop housing 672. The end stop 670 is mainly made from suitable metal components but can be made from other suitable materials and in other suitable configurations.

The end stop housing 672 is mounted on, fixedly connected to, and supported by the upper base 622 of the platform 620.

The extendable stopping member 680 is extendable (such as manually slidable) from the end stop housing 672 from a retracted position to an extended position. In the extended position, the extendable stopping member 680 is configured to engage and apply pressure to one or more end truss members of a truss being built on the second side 10B of the truss assembly table 10.

In other embodiments, the end stop 670 can include an end stop actuator is inside the housing 672 and configured to cause the extendable stopping member 680 to move from the retracted position to the extended position and back to the retracted position. Such an end stop actuator can be suitably connected to the housing and also suitably connected to the extendable stopping member. Such an end stop actuator can be configured in any suitable manner and can be controlled by the control system.

It should thus be appreciated that the end stop assembly 600 is configured to be is an upper position when needed to engage the truss members of the truss being built on the truss assembly table and in a lower position so the built truss can be moved over the end stop assembly 600 to remove the built truss from an end of the truss assembly table.

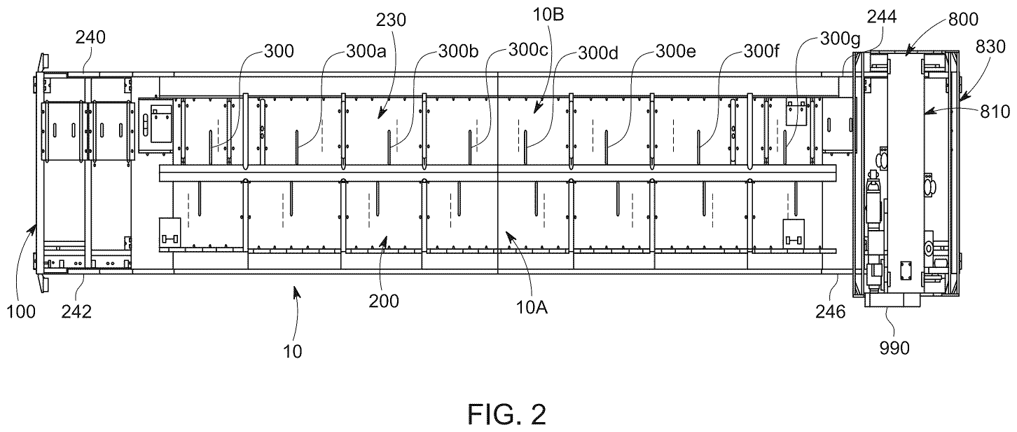

The gantry 800 is longitudinally moveable relative to the table top 100 from one end of the table top 100 (as shown in FIGS. 1 and 2) to an opposite end of the table top 100. As described above, in this example embodiment, at each end of the table top 100, the gantry 800 moves upwardly along the respective set of ramps (i.e., either ramps 240 and 242 or ramps 244 and 246) to make room for a built truss to be moved under the gantry and from the end of the table top 100. The gantry 800 configured to secure connection plates to the truss members (such as chord members and web members) of a truss being built on the table top 100. In alternative embodiments, the ramps can be only at one end of the truss assembly table.

This example gantry 800 includes: (1) a rotatable roller 810; (2) a housing 830; (3) a gear assembly 850; (4) a drive assembly 870; (5) a drive member 890; (6) a sensor assembly 900; and (7) a cover 990. The gantry 800 can includes other suitable components that are not described herein but known in the truss table assembly industry.

The housing 830 is supported by and mounted on an A-frame assembly 832 (see FIG. 1) that partially supports the rotatable roller 810. The A-frame assembly has a first leg (not labeled) and a second leg (not shown) that ride on rails (not labeled) of the table frame 100 to partially support the roller 810 and the housing 830. The housing 830 and the A-frame assembly are mainly made from suitable metal components but can be made from other suitable materials and in other suitable configurations. The housing 830 is thus partially supported by and mounted on the rotatable roller 810 such that when the rotatable roller 810 rotates and moves relative to the table top 200, the housing 830 moves relative to the table top 200.

The roller 810 is configured to roll on the table frame 10. The gantry 800 has additional flanged rollers (not shown) at the bottom of the gantry 800 that run along the bottom rails of the table frame 100 and prevent the gantry 800 from being lifted up when rolling on a truss. The lower rollers are connected to the A-frame 832 with the overall press being adjustable based on the shimming of a main roller bearing (not shown).

The rotatable roller 810 includes a relatively large cylindrical drum 812, a first end wall 814 connected to a first end of the drum 812, and a second end wall (not shown) connected to an opposite second end of the drum 812. When the roller 810 is rotated, as discussed below, the roller 810 moves over the truss members of the truss being built on the truss assembly table 10 and forces the connection plates into those truss members to securely attach the connection plates to those truss members and thus to securely attach the truss members to each other. The rotatable roller is made from suitable metal components but can be made from other suitable materials and in other suitable configurations.

The gear assembly 850 includes a first toothed driven gear 852 and a second toothed driven gear 854 each mounted on an axle 853 that is fixedly connected to the end wall 814 of the rotatable roller 810. The first toothed driven gear 852 and the second toothed driven gear 854 are identical in this example embodiment and are fixedly connected to each other via the main roller axle 853. When the first toothed driven gear 852 and the second toothed driven gear 854 are rotated in a first rotational direction, they cause the roller 810 to rotate in that first rotational direction and thus cause the gantry 800 to move in a first longitudinal direction relative to the table top 200. When the first toothed driven gear 852 and the second toothed driven gear 854 are rotated in an opposite second rotational direction, they cause the roller 810 to rotate in that opposite second rotational direction and thus cause the gantry 800 to move in an opposite second longitudinal direction relative to the table top 200. The gear assembly 850 is made from suitable metal components but can be made from other suitable materials and in other suitable configurations.

The drive assembly 870 includes: (1) an actuator such as a motor (not shown) and a gearbox (not show); (2) a drive shaft 872 extending from the gearbox; (3) a first drive gear 876 fixedly connected to a drive shaft 872 extending from the gearbox; and (4) a second drive gear 878 fixedly connected to the drive shaft 872 extending from the gearbox. The first drive gear 876 and the second drive gear 878 are identical in this example embodiment and are each fixedly connected to each other via the drive shaft 872. When the first drive gear 876 and the second drive gear 878 are rotated in the first rotational direction, they cause the drive member 890 to rotate in that first rotational direction and thus cause the driven gears 852 and 854 to rotate in that first rotational direction (which as described above causes the roller 810 to rotate in that first rotational direction and the gantry 810 to move in the first longitudinal direction). When the first drive gear 876 and the second drive gear 878 are rotated in the opposite second rotational direction, they cause the drive member 890 to rotate in that second rotational direction and thus cause the driven gears 852 and 854 to rotate in that second rotational direction (which as described above causes the roller 810 to rotate in that second rotational direction and the gantry 810 to move in the second longitudinal direction). The drive assembly 870 is mainly made from suitable metal components but can be made from other suitable materials and in other suitable configurations.

The drive member 890 includes a continuous chain journaled about the first and second drive gears 876 and 878 at one end and the first and second tooth driven gears 852 and 854 at the other end. The drive member 890 is made from suitable metal components but can be made from other suitable materials and in other suitable configurations.

The sensor assembly 900 includes: (1) a support bracket 910; (2) a sensor 930; and (3) an electrical connector (not shown).

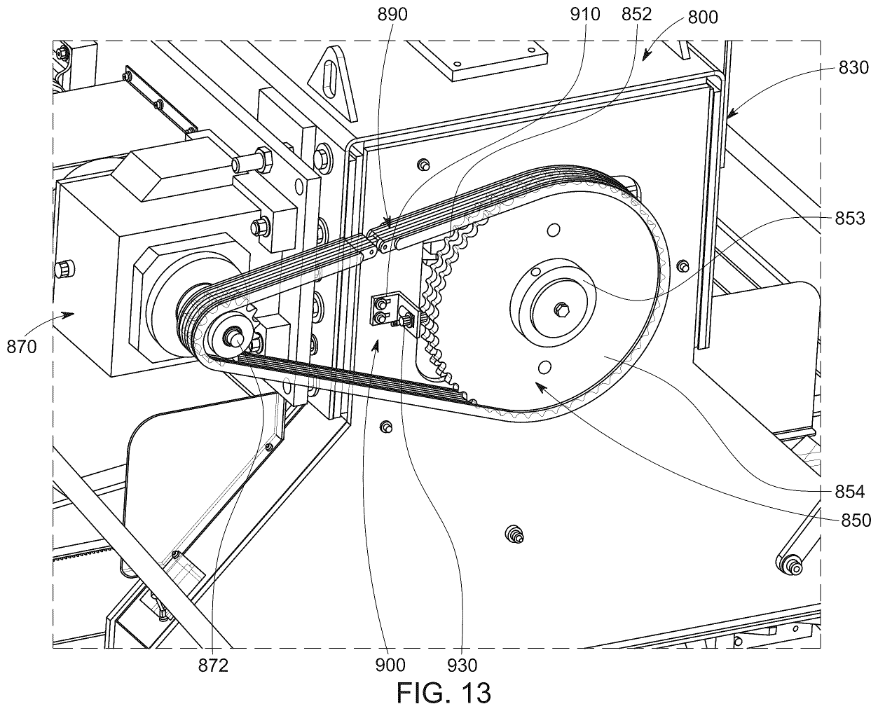

The support bracket 910 includes a first member 912 connected to the side wall (not labeled) of the housing 830 and a second member 914 extending transversely outwardly from the side wall of the housing 830. The support bracket 910 is formed from metal in this example embodiment but can be made from other materials and configured in other manners. The support bracket 910 is positioned relatively close to the driven gears 852 and 854, such as best shown in FIGS. 13, 14, 16, and 17.

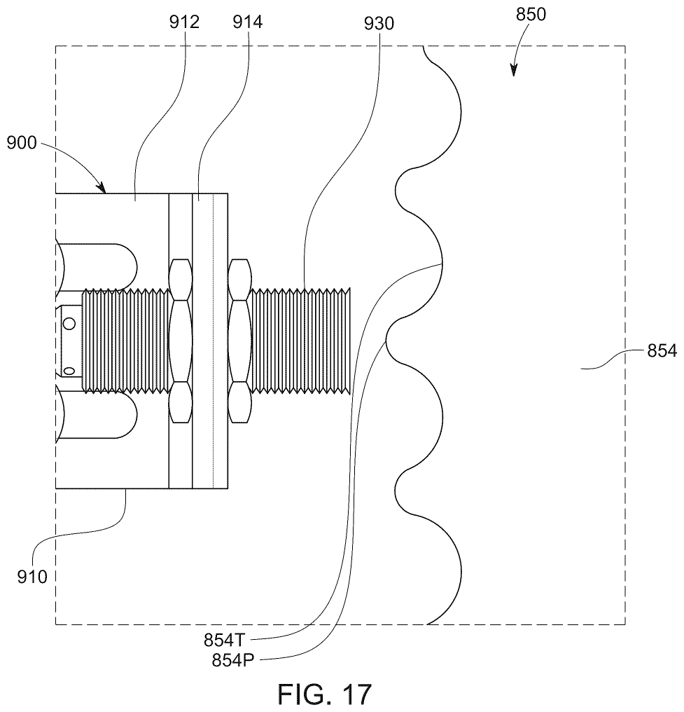

The second member 914 of the support bracket 910 supports the sensor 930 in a location and position aligned with the gear assembly 850 and specifically aligned with the outer second driven gear 854. In this example embodiment, the sensor 930 is aligned with driven gear 854 such that the sensor 930 can send a signal in this example embodiment when each peak such as peak 854P (see FIG. 17) of the gear 854 passes the sensor 930, or in alternative embodiments when each trough such as trough 854T (see FIG. 17) of the gear 854 passes the sensor 930. Thus, as the driven gear 854 is rotated in either rotational direction, the sensor 930 will send a series of signals to the control system. The signals will be based on the speed of the rotation of the driven gear 845 and thus the speed of rotation of the roller 810 (because the driven gear 854 is fixedly connected to the roller 810). The speed is thus directly related to the distance of movement of the roller 810 and the gantry 800.

The sensor 930 is an inductive sensor in this example embodiment, but can be any suitable type of sensor in other embodiments. The sensor 930 creates a magnetic field and when each peak of the gear 854 passes through the magnetic field, the peak in the magnetic field is sensed by the sensor 930. The sensor 930 is configured to send electrical signals to the control system based on such sense peaks. In this example embodiment, the sensor assembly 930 includes one sensor, but it should be appreciated that the sensor assembly can include multiple sensors. In various such embodiments, such multiple sensors can be positioned adjacent to each other and be respectively associated with the different driven gears. In various other embodiments, the sensor assembly can include multiple sensors associated with the same driven gear to better ensure accurate signals sent to the control system.

In various embodiments, the control system is configured to use such signals from the sensor 930 to determine the exact amount of movement of the roller 810 and of the gantry 800 relative to the table top 100. More specifically, the control system can be provided with information regarding a position of the roller 810 and of the gantry 800 relative to the table top 100 such as an initial position at either of the first end of the table top 200 such as shown in FIGS. 1 and 2, or at a second end of the table top 200. When the motor of the drive assembly 870 rotates the drive shaft 872 of the motor which causes the first and second drive gears 876 and 878 to rotate, which causes the drive member 890 to rotate, which causes the first and second driven gears 852 and 854 to rotate, the sensor 930 sends signals to the control system that represent the amount of rotation of the driven gear 854 (based on quantity of the peaks or troughs) that pass the sensor 930. The control system can then use this information to determine the exact amount of longitudinal distance the roller 810 and thus the gantry 800 have moved relative to the table top 200.

In various embodiments, the control system is configured to use such signals received from the sensor 930 to control the exact amount of movement of the roller 810 and thus of the gantry 800 relative to the table top 100. More specifically, the control system can, based on information regarding an initial position of the roller 810 and of the gantry 800 relative to the table top 100 (such as a position at either of the first end of the table top 200 such as shown in FIGS. 1 and 2 or at a second end of the table top 200), control the amount of movement of the roller 810 and thus of the gantry 800 relative to the table top 100. In other words, if the control system wants to move the roller 810 and the gantry 800 a determined distance relative to the table top 200, the control system can cause the motor of the drive assembly 870 to rotate the drive shaft 872 of the motor to cause the first and second drive gears 876 and 878 to rotate, to cause the drive member 890 to rotate, to cause the first and second driven gears 852 and 854 to rotate. The sensor 930 sends signals regarding the movement of the driven gear 854 to the control system that represent the amount of rotation of the driven gears (based on quantity of the peaks or troughs of the driven gear 854) that pass the sensor 930. The control system uses this information to control the exact amount of longitudinal distance that the roller 810 and the gantry 800 move relative to the table top 200.

In various embodiments, the control system (not shown) includes one or more manually controlled switching mechanisms.

In various embodiments, the control system includes one or more PLC boards or is integrated into one or more PLC boards.

In various embodiments, the control system includes one or more processing devices communicatively connected to one or more memory devices.

In various embodiments, the control system includes a programmable logic control system. The processing device can include any suitable processing device such as, but not limited to, a general-purpose processor, a special-purpose processor, a digital-signal processor, one or more microprocessors, one or more microprocessors in association with a digital-signal processor core, one or more application-specific integrated circuits, one or more field-programmable gate array circuits, one or more integrated circuits, and/or a state machine.

In various embodiments, the control system includes one or more memory devices. Each memory device can include any suitable memory device such as, but not limited to, read-only memory, random-access memory, one or more digital registers, cache memory, one or more semiconductor memory devices, magnetic media such as integrated hard disks and/or removable memory, magneto-optical media, and/or optical media. Each memory device stores instructions executable by the processing device to control operation of the truss assembly table 10.

In various embodiments, the control system is communicatively and operably connected to the actuators including the servo motors, sensors, the operator interface, and the power supply, and configured to receive signals from and send signals to those components.

In various embodiments, the control system is communicatively connectable (such as via Wi-Fi, Bluetooth, near-field communication, or other suitable wireless communications protocol) to an external device, such as a computing device, to send information to and receive information from that external device.

The operator interface can include a suitable display screen with a touch panel. In such embodiments with a display screen, the display screen is configured to display information regarding the truss assembly table 10, and the touch screen is configured to receive operator inputs. The operator interface is communicatively connected to the control system to send signals to the control system and to receive signals from the control system. Other embodiments of the truss assembly table 10 do not include a touch panel. Still other embodiments of the truss assembly table 10 do not include a display assembly. Certain embodiments of the truss assembly table 10 include a separate pushbutton panel instead of a touch panel beneath or integrated with the display screen. In certain embodiments of the truss assembly table 10, the operator interface includes one or more pushbuttons (and associated light) and no display screen or touch panel.

In various embodiments, the power supply is electrically connected to (via suitable wiring and other components) and configured to power several components of the truss assembly table 10. In various embodiments, the power supply can include a pneumatic air power supply.

It will be understood that modifications and variations may be affected without departing from the scope of the novel concepts of the present invention, and it is understood that this application is to be limited only by the scope of the claims.

The claims are as follows:

1. A truss assembly table comprising:
a table frame;
a table top connected to the table frame;
a gantry supported by the table frame and movable from a first end of the table top to a second end of the table to, the gantry comprising:
a rotatable roller including a cylindrical drum and a first end wall connected to a first end of the drum,
a gear assembly including a toothed driven gear fixedly connected to the rotatable roller,
a sensor aligned with the driven gear such that the sensor can send a signal when one of: (a) each peak of the driven gear passes the sensor, or (b) each trough of the driven gear passes the sensor; and
a control system configured to control a distance of movement of the roller based on the signals received from the sensor.

2. The truss assembly table of claim 1, wherein the control system is configured to use the signals from the sensor to determine an amount of movement of the roller relative to the table top.

3. The truss assembly table of claim 1, wherein the control system is configured to use the signals from the sensor to control an amount of movement of the roller relative to the table top.

4. A truss assembly table comprising:
a table frame;
a table top connected to the table frame;
a gantry supported by the table frame and movable from a first end of the table top to a second end of the table to, the gantry comprising:
a rotatable roller including a cylindrical drum and a first end wall connected to a first end of the drum,
a gear assembly including a toothed driven gear mounted on an axle that is fixedly connected to the first end wall of the rotatable roller,
a drive assembly including an actuator having a drive shaft and a drive gear fixedly connected to a drive shaft,
a drive member including a continuous chain journaled about the drive gear and the driven gear, such that when the drive gear is rotated in a first rotational direction, the drive gear causes the drive member to rotate in that first rotational direction and causes the driven gear to rotate in that first rotational direction which causes the roller to rotate in that first rotational direction and roller to move in a first longitudinal direction, and when the drive gear is rotated in an opposite second rotational direction, the drive gear causes the drive member to rotate in that second rotational direction and causes the driven gear to rotate in that second rotational direction which causes the roller to rotate in that second rotational direction and the roller to move in the second longitudinal direction, and
a sensor assembly including a sensor and a support bracket that supports the sensor in a location and in a position aligned with the driven gear such that the sensor can send a signal when each peak of the driven gear passes the sensor or when each trough of the driven gear passes the sensor; and
a control system configured to control a distance of movement of the roller based on the signals received from the sensor.

5. The truss assembly table of claim 4, wherein the control system is configured to use the signals from the sensor to determine an amount of movement of the roller relative to the table top.

6. The truss assembly table of claim 4, wherein the control system is configured to use the signals from the sensor to control an amount of movement of the roller relative to the table top.
